(19) United States
(12) Patent Application Publication
(10) Pub. No.: US 2020/0247020 A1
(43) Pub. Date: Aug. 6, 2020

(54) COSMETICS CONTAINER AND MANUFACTURING METHOD THEREOF

(71) Applicant: CHEN-CHANG KUO, Changhua (TW)

(72) Inventor: CHEN-CHANG KUO, Changhua (TW)

(73) Assignee: TOO CHARMING ENT. CO., LTD., CHANGHUA (TW)

(21) Appl. No.: 16/264,026

(22) Filed: Jan. 31, 2019

(51) Int. Cl. B29C 45/00; A45D 40/00; A45D 33/00; B29B 9/14

(52) U.S. Cl. CPC B29C 45/0005; A45D 40/00; A45D 33/006; B29C 45/0001; B29K 2001/08; A45D 2040/0025; B29K 2003/00; B29K 2005/00; B29B 9/14

(57) ABSTRACT

A cosmetic container and manufacturing method thereof may include steps of obtaining raw material, mixing granulation, and molding by injection to manufacture a cosmetic container. In the step of obtaining raw material, a plurality of fibers as main raw material of the cosmetic container are extracted from natural plants. In the step of mixing granulation, the extracted fibers are configured to mix with a plentiful vegetable gum and starch, and the mixed compound is adapted to be granulated through a granulating machine to form into a plurality of granules. Thereafter, in the step of molding by injection, the granules is sent into a processor, and the processor is configured to heat and melt the granules and to inject and fill the melted compound in a plurality of mold cavities of a forming mold.

### FIELD OF THE INVENTION

The present invention relates to a cosmetic container and more particularly to an environmental cosmetic container and manufacturing method thereof.

### BACKGROUND OF THE INVENTION

Nowadays, the cosmetic container in the market such as the container of lipstick, facial cream, lotion, or palette is made of plastic. Usually, the plastic cosmetic container is painted or designed in overall appearance to enhance the value of cosmetics. However, the plastic cosmetic container is more likely to cause environmental pollution. Therefore, there remains a need for a new and improved design for a cosmetic container and manufacturing method thereof to overcome the problems presented above.

### SUMMARY OF THE INVENTION

The present invention provides a cosmetic container and manufacturing method thereof which comprises steps of obtaining raw material, mixing granulation, and molding by injection to manufacture a cosmetic container. In the step of obtaining raw material, a plurality of fibers as main raw material of the cosmetic container are extracted from natural plants such that the toxic gas and smoke are not generated when the cosmetic container is burned, and residues of the burned cosmetic container are adapted to be naturally discomposed when buried, thereby achieving environmental effect. The step of mixing granulation is processed after the obtaining raw material, the extracted fibers are configured to be mixed with a plentiful vegetable gum and starch, and the mixed compound is adapted to be granulated through a granulating machine to form into a plurality of granules. The step of molding by injection is processed after the step of mixing granulation, the granules are sent into a processor, and the processor is configured to heat and melt the granules and to inject and fill the melted compound into a plurality of mold cavities of a forming mold. After proper cooling, the forming mold is opened, and the cosmetic container is manufactured. The manufactured cosmetic container comprises an outer periphery, an open end, and a closed end, and a housing is formed inside the outer periphery between the open end and closed end. Also, the housing is communicated with the open end. In one embodiment, the cosmetic container is formed into a main body and a lid to accommodate a cosmetic. In another embodiment, the cosmetic container is used as a cover to receive a thinning plastic shell through the open end and the housing, thereby reducing the use of plastic.

Comparing with conventional cosmetic container and manufacturing method thereof, the present invention is advantageous because: (i) the raw material of the cosmetic container is natural fibers which is environmental; and (ii) the cosmetic container can be also used as the cover to receive the thinning plastic shell, which reduces the use of plastic.

### BRIEF DESCRIPTION OF THE DRAWINGS

FIG. 1 is a flow chart of a cosmetic container and manufacturing method thereof of the present invention.

FIG. 2 is a schematic view of a step of mixing granulation in the present invention.

FIG. 3 is a schematic view of a step of molding by injection in the present invention.

FIG. 4 is a three-dimensional view of a first embodiment of a cosmetic container of the present invention.

FIG. 5 is a three-dimensional view of a second embodiment of the cosmetic container of the present invention.

FIG. 6 is a three-dimensional view of a third embodiment of the cosmetic container of the present invention.

FIG. 7 is a three-dimensional view of a fourth embodiment of the cosmetic container of the present invention.

FIG. 8 is a sectional view of the fourth embodiment of the cosmetic container of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

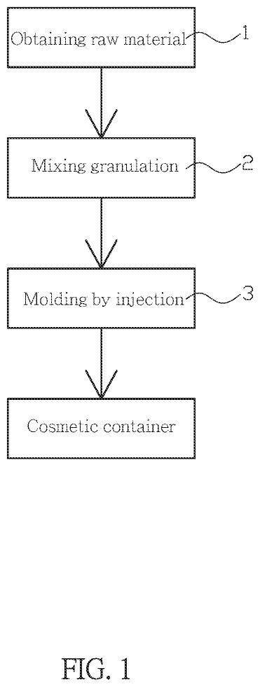

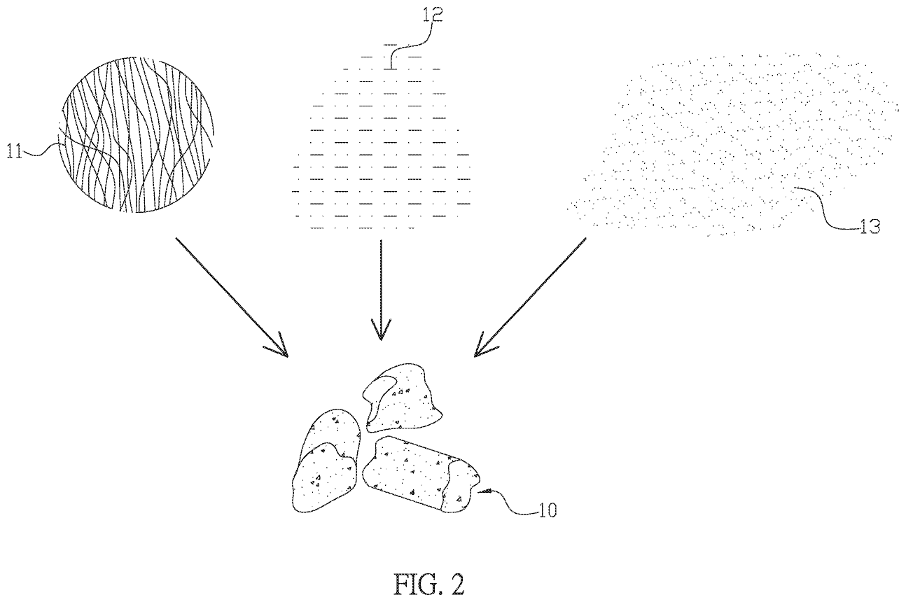

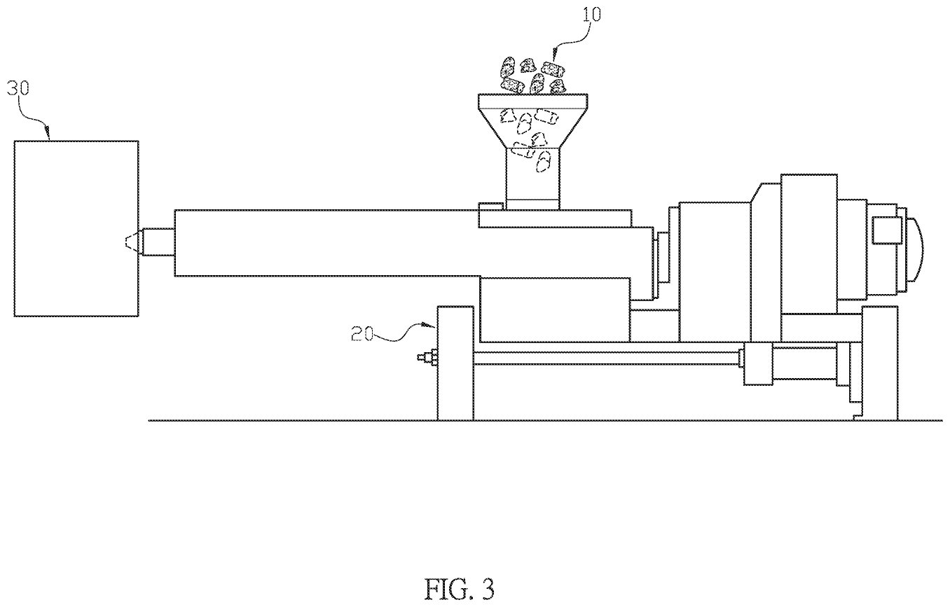

Referring to FIG. 1, the present invention provides a cosmetic container and manufacturing method thereof which comprises steps of obtaining raw material (1), mixing granulation (2), and molding by injection (3) to manufacture a cosmetic container (40). In the step of obtaining raw material (1), a plurality of fibers (11) as main raw material of the cosmetic container (40) are extracted from natural plants such that when the cosmetic container (40) is burned, the toxic gas and smoke are not generated, and residues of the burned cosmetic container (40) are adapted to be discomposed when buried, thereby achieving environmental effect. The step of mixing granulation (2) is processed after the obtaining raw material (1), the extracted fibers (11) are configured to be mixed with a plentiful vegetable gum (12) and starch (13), and the mixed compound is adapted to be granulated through a granulating machine to form into a plurality of granules (10) (as shown in FIG. 2). The step of molding by injection (3) is processed after the step of mixing granulation (2), the granules (10) are sent into a processor (20) (as shown in FIG. 3), and the processor (20) is configured to heat and melt the granules (10) and to inject and fill the melted compound into a plurality of mold cavities of a forming mold (30). After proper cooling, the forming mold (30) is opened, and the cosmetic container (40) is manufactured. The manufactured cosmetic container (40) comprises an outer periphery (401), an open end (402), and a closed end (403), and a housing (404) is formed inside the outer periphery (401) between the open end (402) and closed end (403). Also, the housing (404) is communicated with the open end (402).

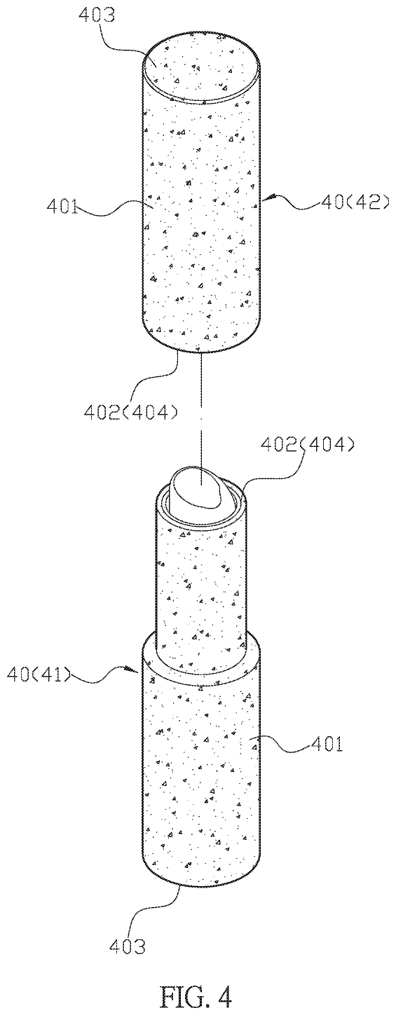

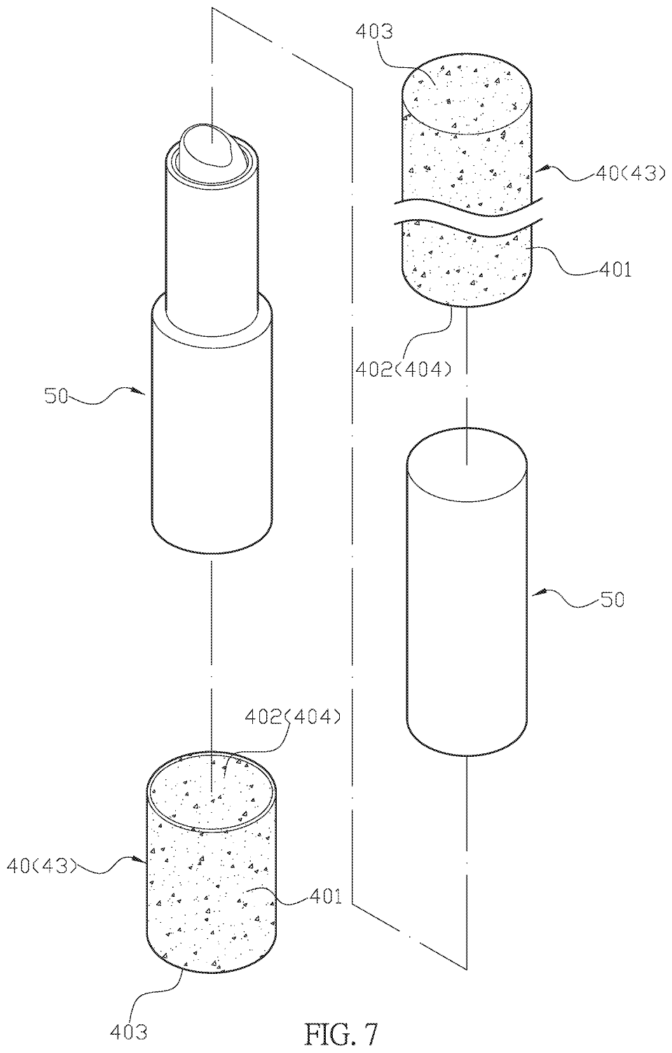

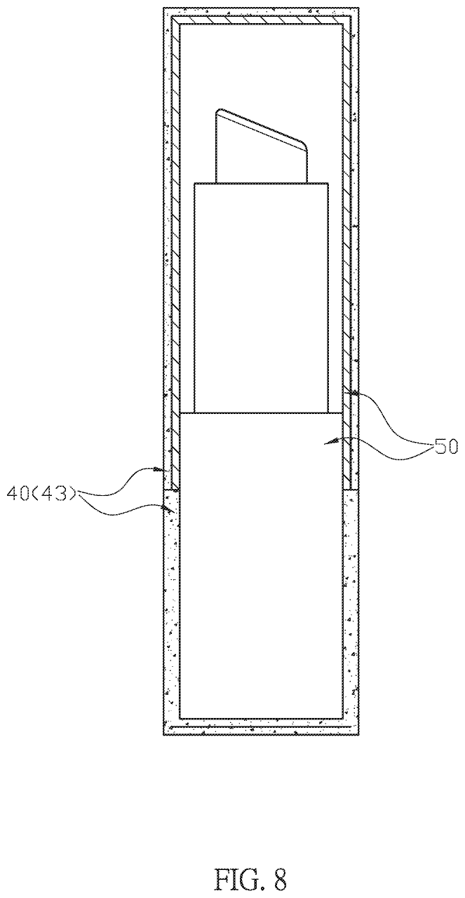

In actual application, the cosmetic container (40) is formed into a main body (41) and a lid (42) to accommodate a cosmetic (as shown in FIGS. 4 to 6), or the cosmetic container (40) is adapted to receive a thinning plastic shell (50) through the open end (402) and the housing (404) so as to enable the cosmetic container (40) to be used as a cover (43) (as shown in FIGS. 7 and 8), thereby reducing the use of plastic.

In one embodiment, the extracted fibers (11) are pulverized into an appropriate size before processed through the step of mixing granulation (2).

In another embodiment, the processor (20) is a thermo-compressor.

In still another embodiment, the processor (20) is an injection molding machine.

In a further embodiment, the cosmetic container (40) is used for a cosmetic such as lipstick, lip cream, or lip gloss (as shown in FIG. 4).

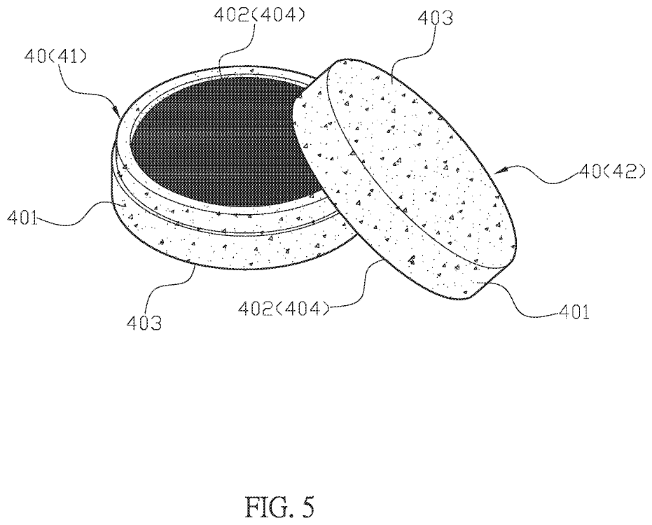

In still a further embodiment, the cosmetic container (40) is used for a cosmetic such as facial cream and powder makeup (as shown in FIG. 5).

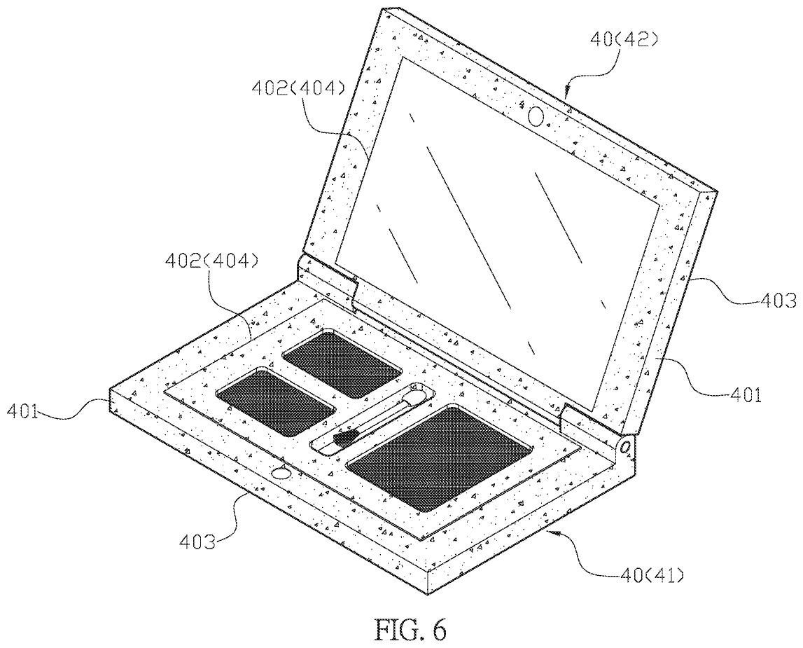

In a particular embodiment, the cosmetic container (40) is used for a cosmetic such as eye shadow, cream blush (as shown in FIG. 6).

Comparing with conventional cosmetic container and manufacturing method thereof, the present invention is advantageous because: (i) the raw material of the cosmetic container (40) is natural fibers (11) which is environmental; and (ii) the cosmetic container (40) can be also used as the cover (43) to receive the thinning plastic shell (50), which reduces the use of plastic.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A cosmetic container and manufacturing method thereof comprising steps of obtaining raw material, mixing granulation, and molding by injection to manufacture a cosmetic container;
wherein in the step of obtaining raw material, a plurality of fibers as main raw material of the cosmetic container are extracted from natural plants such that the toxic gas and smoke are not generated when the cosmetic container is burned, and residues of the burned cosmetic container are adapted to be naturally discomposed when buried, thereby achieving environmental effect;
wherein the step of mixing granulation is processed after the step of obtaining raw material; the extracted fibers are configured to be mixed with a designated amount of vegetable gum and starch, and the mixed compound is adapted to be granulated through a granulating machine to form into a plurality of granules; and
wherein the step of molding by injection is processed after the step of mixing granulation; the granules are sent into a processor, and the processor is configured to heat and melt the granules and to inject and fill the melted compound into a plurality of mold cavities of a forming mold; after proper cooling, the finished cosmetic container is took out from the forming mold; wherein the manufactured cosmetic container comprises an outer periphery, an open end, and a closed end, and a housing is formed inside the outer periphery between the open end and closed end, and the housing is communicated with the open end; the cosmetic container is formed into a main body and a lid to directly accommodate a cosmetic, or the cosmetic container is used as a cover to receive a thinning plastic shell through the open end and the housing, thereby reducing the use of plastic.

2. The cosmetic container and manufacturing method thereof of claim 1, wherein the extracted fibers are pulverized into an appropriate size before processed through the step of mixing granulation.

3. The cosmetic container and manufacturing method thereof of claim 1, wherein the processor is a thermo-compressor.

4. The cosmetic container and manufacturing method thereof of claim 1, wherein the processor is an injection molding machine.
